(19) United States
(12) Patent Application Publication
(10) Pub. No.: US 2015/0217840 A1
(43) Pub. Date: Aug. 6, 2015

(54) Light Altering Rub Rail and Rub Rail Insert

(71) Applicant: Zachary Taylor, Wells, ME (US)

(72) Inventor: Zachary Taylor, Wells, ME (US)

(21) Appl. No.: 14/613,549

(22) Filed: Feb. 4, 2015

Related U.S. Application Data
(60) Provisional application No. 61/935,715, filed on Feb. 4, 2014.

(51) Int. Cl. B63B 59/02; B60J 10/00; B63B 45/04

(52) U.S. Cl. CPC B63B 59/02; B63B 45/04; B60J 10/0002; B63B 2231/42

(57) ABSTRACT

A light altering rub rail comprising (1) an elastic, semi-rigid translucent polymer base having at least a body portion with proximal and distal ends, top and bottom ends and front and rear faces; (2) an access flap forming the majority of the base front face creating a gap in the base; (3) a light source embedded within the gap in the base; (4) a plurality of mounting lobes at the proximal and distal end portions; and (5) a plurality of linear light refractors embedded within the base wherein the gap in the base may be sealed to create a fully enclosed water-proof housing.

### RELATED APPLICATIONS

This application claims priority to U.S. Provisional Application No. 61/935,715 filed Feb. 4, 2014. The entire contents of the above application are hereby incorporated by reference as though fully set forth herein.

### FIELD

The present invention relates to a molding trim, and more particularly to a rub rail for boats and ships.

### BACKGROUND

Traditionally, rub rails wrap watercrafts of different types and sizes along the perimeter to protect it from damage. Rub rails are usually not illuminated, in the case of inclement weather or during the night when visibility is lowered the vehicle's actual size and shape is unknown to others—including the operator and those in the vessel. During docking the perimeter of the boat and the location of the dock need to be apparent and an illuminated rub rail ensures the two are visible to safely dock.

The addition requirement of a secondary lighted bumper object requires twice the amount of material and is prone to breakage. Placing the light source below the OEM rub rail puts the light source in a very dangerous position to be knocked off or damaged since at this level, below the rail, majority of the docks are at this height and will likely dislodge the light. If the light source was embedded behind the rub the articulated form of the hull protects rail the light and the elastic plastic would protect the light source from damage.

Marine and automotive bumpers are designed to protect the vehicle when it comes in contact with another object. A rub rail is the key component in preventing damage to both, the docking vehicle and the dock. While the operator is attempting to dock it is crucial the operator can properly see both the extent of the outline of the vehicle and the dock. An illuminated rub rail provides ambient light to the surrounding surfaces as well as provides a clear, distinguished line of illumination around the perimeter of the docking vessel.

An application is needed were the light is emitted around the boat, outlining the vessel to clearly indicate the size, shape and location. There have been a few attempts in the prior art to meet this need, for example the U.S. Pat. No. 7,258,472 to Tufte has an additional strip of lights below the rub rail. The position of the rub rail in Tufte is not ideal since the original rub rail blocks the light produced from the additional strip of lights, thereby only allowing light to be visible for those who are away from the vessel. The operator and others who are on board will not see the effects of the light from the additional light source. b. As such, two light sources are required with one above the rub rail and another below the rub rail to provide adequate amount of light to for both the individuals on board and those viewing the vessel.

### BRIEF SUMMARY OF THE INVENTION

The present invention discloses a uniquely formed, light altering rub rail and rub rail inserts that are designed to amplify amounts of visible light from a self-contained, integrated light source. Following the standard shapes of rub rails, the form is generally an arc or a round-cornered square mounted directly to the side of a boat with either adhesive and/or screws. The rub rail insert shares a similar shape to the rub rail with the only difference is that the insert is held in place by a tongue and groove system. These inserts are much smaller than the full rub rail and so the light altering affects need be more pronounced in order to distribute light. Some rub rails are designed to accommodate a metal strip running along the entire front face of the rail to help hold the rail in place and for additional protection for the vessel. The light altering rub rail is comprised of a semi-rigid translucent (opaque) plastic material that allows light to emit from the internally located light source. Translucent materials, like frosted light bulbs, continuously reflect light while the white color allows the non-visible light to illuminate the material that generates a visible light to produce a glowing affect. In front of the internal light source is at least one articulated form designed to bend/distort light more evenly thereby reducing the harsh, high intensity light to more visible less damaging light to the human eyes. This light is directed evenly upward and downward across the hull of the boat and outward onto the water illuminating not only the perimeter the boat but also any objects in the immediate vicinity such as docks, other water crafts, and people swimming around the boat.

BRIEF DESCRIPTION OF THE DRAWINGS

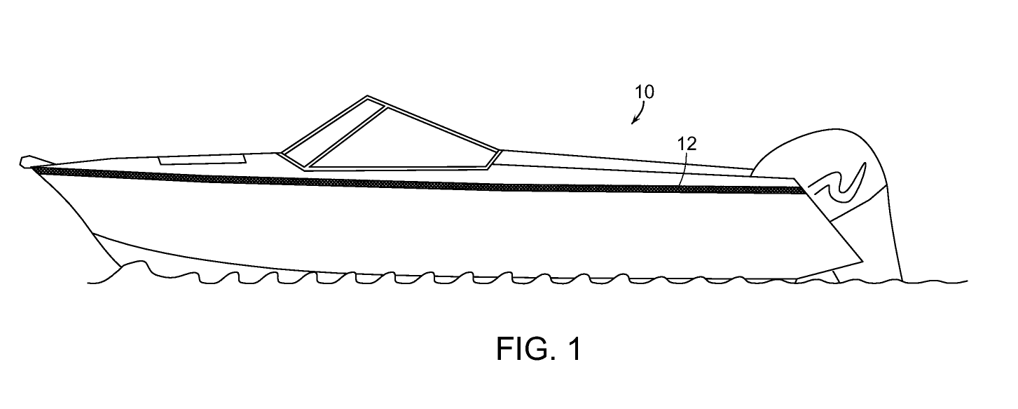

FIG. 1. Illustrates where the rub rail and rub rail insert should be mounted to the vessel.

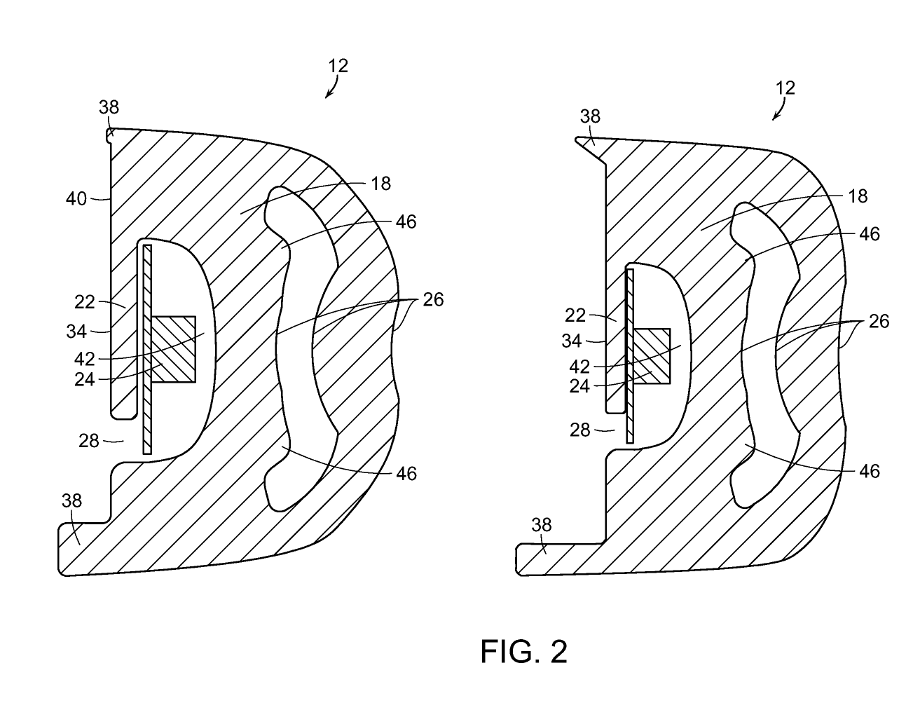

FIG. 2. Illustrates the cross section of the light altering rub rail.

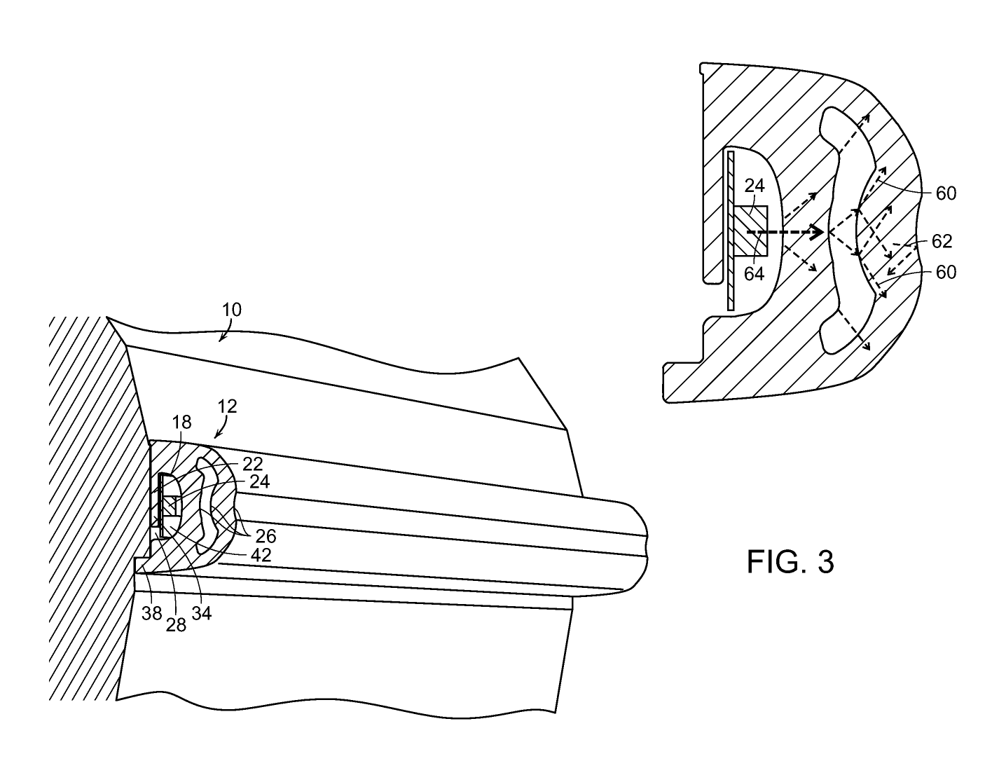

FIG. 3. Illustrates a sectional perspective of the light altering rub rail.

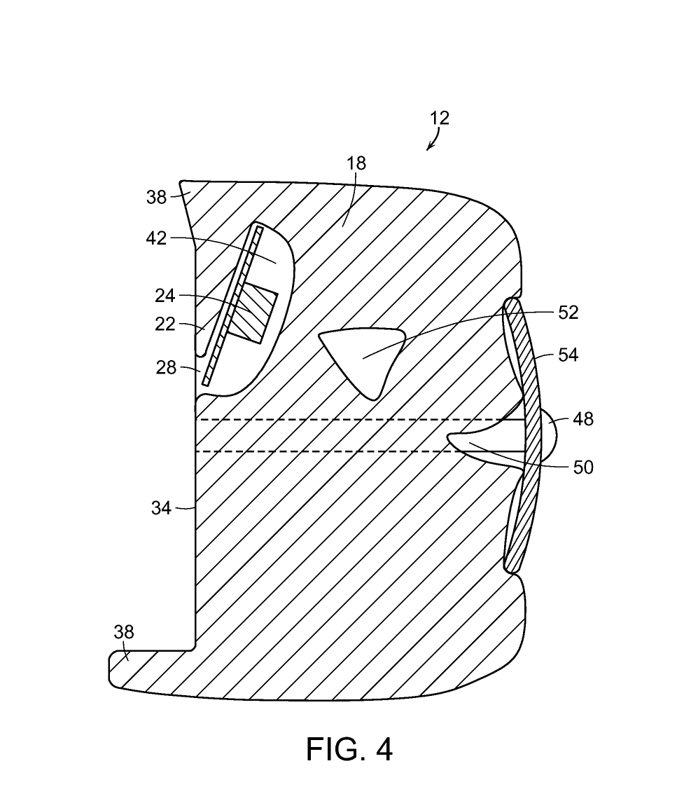

FIG. 4. Illustrates a sectional perspective of the light altering rub rail with the attached metal face.

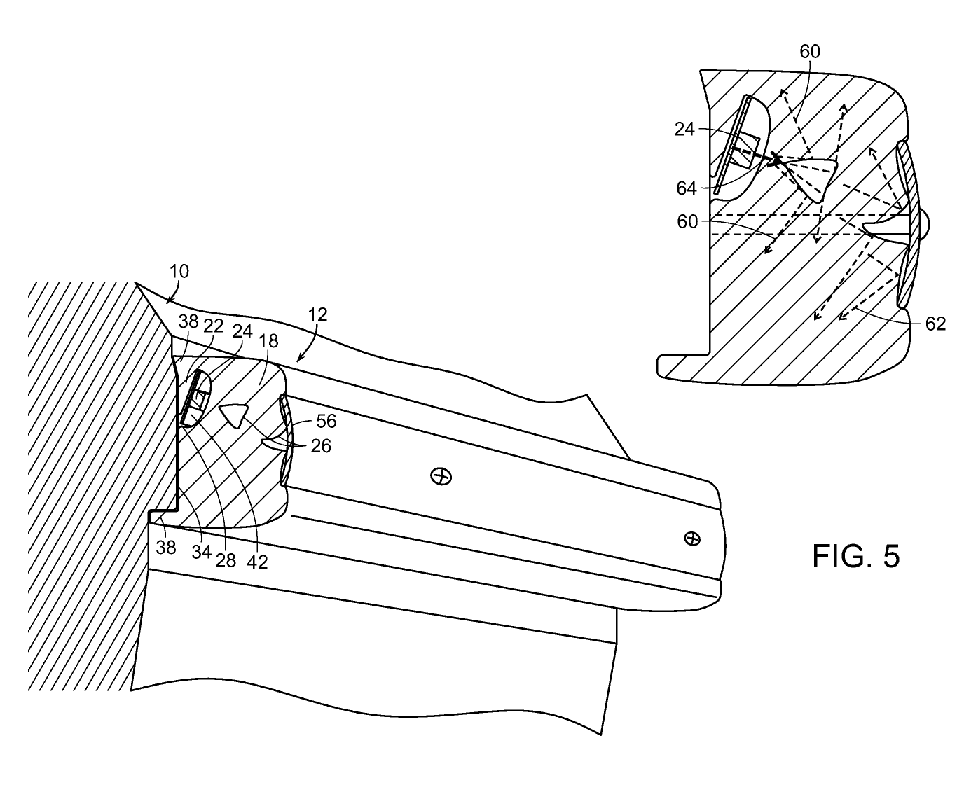

FIG. 5. Illustrates a sectional perspective of the light altering rub rail with the attached metal face.

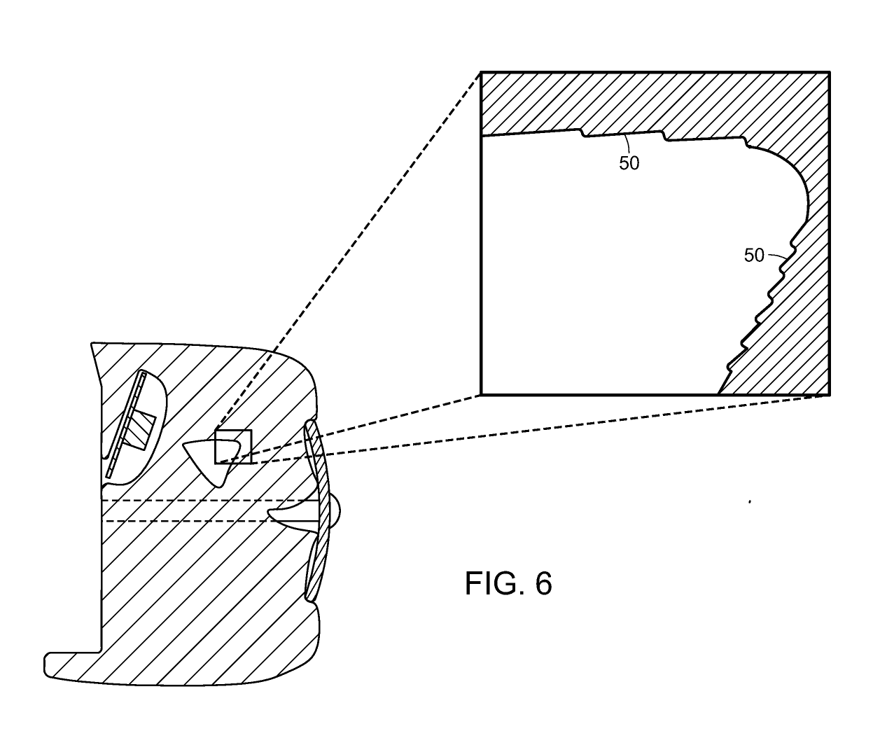

FIG. 6. Illustrates the detailed necessary in altering the light of the concave light refractor and how light is refracted in the two versions.

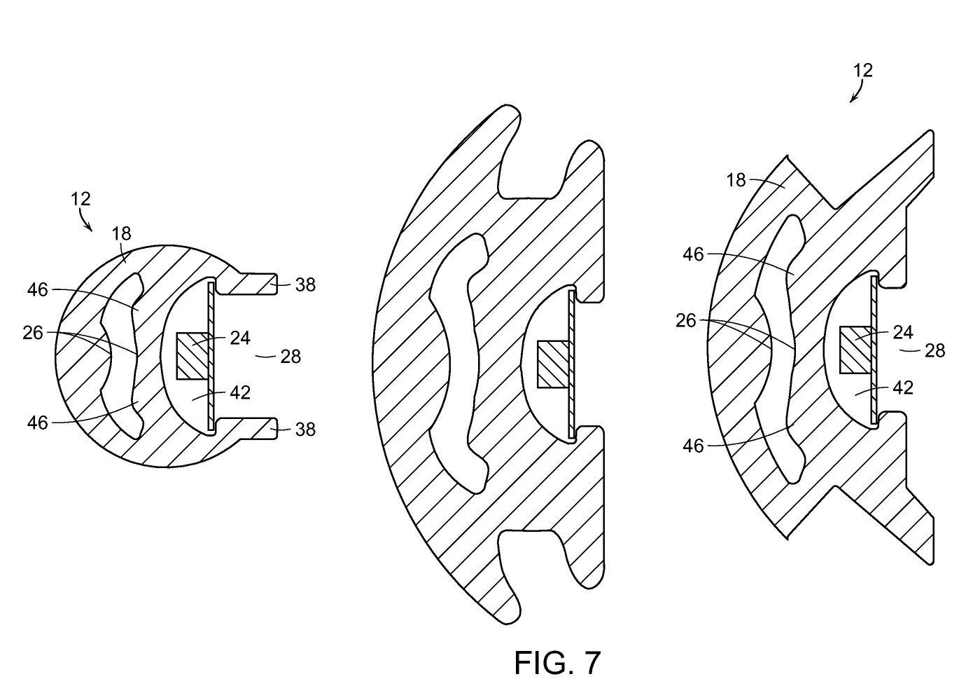

FIG. 7. Illustrates possible varying rub rail inserts to incorporate the light altering design.

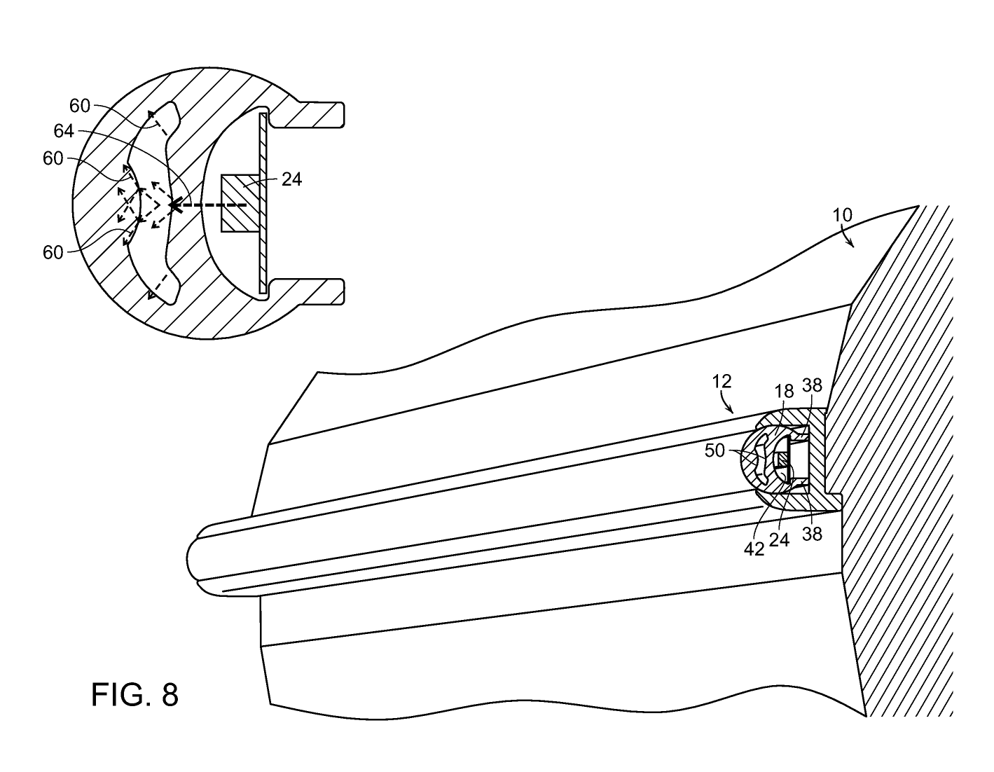

FIG. 8. Illustrates how the light altering rub rail inserts fit into the rub rail housing.

### DETAILED DESCRIPTION

In the preferred embodiment of the light altering rub rail and rub rail inserts the present invention is comprised of a translucent (opaque) polymer to help amplify the visible effects of the light. Light is reflected inside the material and diffused to create a glowing affect using indirect diffused light like a fluorescent tube as shown in further detail in FIG. 6. If the material was not translucent, such as something more transparent, light would pass through the bumper uninterrupted and remain invisible to the naked eye, therefore the light is useless.

Turning to FIG. 1, the light altering rub rail and rub rail insert of the elastic, semi-rigid translucent polymer 12 is attached to the side of a water craft or vessel along the entire perimeter to prevent damage to the hull. The mounting face 40 in FIG. 2 is attached to the face of the hull where the rub rail or rub rail insert is to be mounted replacing the standard rail. Two mounting lobes 12 at either ends of the mounting face 40 are designed to secure the rail to the hull helping to create a water proof seal ensuring the rail stays attached and to prevent water from damaging the light source 48. There is an access flap 22 forming the majority of the mounting face 40 and a formed gap 28 allowing an individual to pry said access flap 22 open and obtain access to the light source 48. After the light source as been accessed the flap 22 will fold back into position and the formed gap can be sealed with silicon creating a fully enclosed, water proof light source housing 42.

Progressing outward from the internal light source housing 42, FIG. 2 exhibits the primary components of the light altering rub rail in the version without the metal strip the three linear concave light refractors 26 will bend as much light as possible for even distribution. The first linear concave light refractor 26 immediately in front of the internal light source forms a dual concave lens with the light source housing to bend light helping to reduce the harmful effect of high intensity glare while not lowering the amount of visible light. Adjacent to the first concave light refractor 26 is a second refractor 26 with symmetrically designed light dispensing lobes 46 to help dispense light vertically to lower the intensity of the light while increasing the amount of visible light. These lobes act as a magnifying glass in the sun- creating two concentrated beams of light by splitting the directionality of the light into two and directing it outward. Finally, in one embodiment, in the version without the metal face there is one final light refractor 26 to increase the light distributing ability. This final refractor 26 also acts as a reflector as well to reflect light back throughout the entire translucent pump to help promote an even distribution of light. There may be a white painted back 34 to ensure any light that is reflected backward towards the light source is not absorbed by the item to which it is attached. The color white is preferable as it has the highest ability to reflect light than any other color and if the light source 24 produces any other color than white, the white backing 34 is the best color to ensure that color is portrayed properly.

FIG. 2 shows an additional embodiment of the rub rail that is comprised generally of the same components and materials such as an elastic, semi-rigid translucent polymer. The only difference in the two rail embodiments is the general varying shape. Due to all the different boats, boat manufacturers, years and styles, rub rails vary slightly in size and shape yet are all rub rails are designed to serve one purpose, to protect the vessel to which it is attached. As a result the design has to reflect the varying configurations. The bottom rub rail I FIG. 2 is slightly wider than the one above and the two mounting lobes 38 are much larger to better fit with the form of the boat to ensure the most water proof seal possible. FIG. 3 shows a sectional perspective of how the rub rail is attached to the boat. The top of the bumper just before the face of the bumper curves back in to form the top mounting lobe 38 is designed to have a slight pitch. This pitch allows water to run down the side of the vessel unimpeded and prevents water from seeping past the lobe 38 and into the light source 24, thereby ruining the system.

FIG. 4 is a further embodiment of the present invention showing the light altering rub rail with the metal face. This rail incorporates all the same features into the design as the previously mentioned light altering rub rail light this rub rail has a metal plate attached to the front face. The primary difference is the linear triangular concave light refractor 52 and the second linear concave light reflector 52. The first light refractor is in the shape of a triangle to more aggressively bend light dispensing it laterally to avoid any light from becoming trapped behind the metal strip 42. In FIG. 6 there is a detailed drawing of the exact shape of the refractor 52. The refractor 52 is actually composed of very small saw tooth-like faces 50 to help direct the light outward towards the sides of the rail.

To optimize the amount of visible light, a linear concave light reflector 50 is on the backside of the metal strip and it does not allow the light to be trapped behind the strip 42 optimizing visibility. This reflector can be painted white to enhance the reflective quality since white reflects the most amount of light. This reflector forms a V-shape; the top of the “V” is a concave form while the bottom of the “V” is convex. Since the light source 24 is inserted at an angle these two forms help to reflect light differently, the concave form has to reflect light at a sharper angle outward towards the top side of the rail and since the light source is already pointed downward a convex reflector is implemented to reflect light more gradually. These reflectors ensure the entire rail is evenly illuminated.

The light source 24 is located on the top of the rub rail angled downward for two reasons. One, the light source 24 is angled downward to reduce glare for individuals viewing the rail at close distances while greatly increasing the rail ability to illuminate the water below. By aiming the light source 24 downward towards the water, the water reflect light to help illuminate the haul of the vessel, the water and any objects nearby. By placing the light source 24 at the top and angled water that penetrates the light source housing 42 will drain out due to gravity preventing any damage.

This rub rail with the metal strip 42 may be held in place with screws seen in FIGS. 4 and 5 going through the metal strip, the rub rail, and then into the vessel to ensure the rail will not be torn off. The screws will be self-tapping and may be completely removed from the light refractor 26 and the light source housing 42. This separation from the screws and the light source housing 42 ensures that the light source 24 remains protected from damaging blows and harmful water.

FIG. 7 illustrates some of the varying rub rail insert options. Since there are numerous boat manufacturers, models, years and sizes of boats, rub rail inserts can vary greatly. These inserts are designed with the same crucial elements from the previously mentioned light altering rub rails starting with the ability to hold the light source 24 in the light source housing 42. There are also the dual and single concave light refractors 26, along with the light dispensing lobes 46 to help prevent blinding glare and creating a more even distribution of light for a more enjoyable experience. The original inserts can be simply removed and with some simple wiring and by applying pressure systematically along the line onto the new light altering rub rail insert to properly insert the system.

The primary operation of the light altering rub rail and rub rail inserts is to protect objects such as boats, planes and cars from coming in contact with the hard surfaces while illuminating the object it is attached to and the surrounding area. The rub rails and the rub rail inserts with a small mounting bracket can be attached to any flat rough or hard surface such as but not limited to marine boats, water crafts, railings, jet skis, snowmobiles, trucks, docks, loading docks, decks, wharfs, guard rails, pilings, posts, moorings, buoys, jetties, and piers. The internal light source may have the ability to change color, frequency and brightness with the use of remote, timers, control panel or Wi-Fi device.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A light altering rub rail comprising:
a. An elastic, semi-rigid translucent polymer base having at least a body portion with proximal and distal ends, top and bottom ends and front and rear faces;
b. An access flap forming the majority of the base front face creating a gap in the base;
c. A light source embedded within the gap in the base;
d. A plurality of mounting lobes at the proximal and distal end portions; and
e. A plurality of linear light refractors embedded within the base
wherein the gap may be sealed to create a fully enclosed water-proof housing.

2. The rub rail of claim 1 wherein a first light refractor is concave and positioned in front of the internal light source and forms a dual or single concave lens with the light source housing.

3. The rub rail of claim 2 wherein the first concave light refractor is in the shape of a triangle.

4. The rub rail of claim 3 wherein the first concave light refractor directs light towards the proximal and distal ends of the base.

5. The rub rail of claim 1 further comprising a plurality of light dispensing lobes positioned on the top and bottom ends of the base.

6. The rub rail of claim 5 wherein a second light refractor is concave and dispenses light vertically through the light dispensing lobes.

7. The rub rail of claim 1 wherein a third light refractor is concave and reflects light internally throughout the base.

8. The rub rail of claim 1 further comprising a painted rear surface to reflect light that is reflected backward towards the light source.

9. The rub rail of claim 8 wherein the painted rear surface is white.

10. The rub rail of claim 1 wherein the light source is positioned at the top end of the polymer base and angled downward.

11. The rub rail of claim 1 further comprising a metal plate attached to the front face of the base.

12. The rub rail of claim 11 further comprising a linear light reflector attached to the back side of the metal plate wherein the top of the reflector is concave and the bottom of the reflector is convex.

13. The rub rail of claim 1 wherein the internal light source is capable of changing color, frequency or brightness.

14. The rub rail of claim 13 wherein such changes in color, frequency or brightness are enabled by the use of remote controls, timers, control panel or wireless devices.

15. A method for forming a light altering rub rail comprising the steps of:
a. Forming an access flap in an elastic, semi-rigid translucent polymer base having at least a body portion with proximal and distal ends, top and bottom ends and front and rear faces wherein the flap creates a gap in the base;
b. Embedding a light source within a gap;
c. Embedding a plurality of linear light refractors in the base; and
d. Sealing the gap to create a fully enclosed water-proof housing.

16. The method of claim 15 wherein a first light refractor is concave and positioned in front of the internal light source and forms a dual or single concave lens with the light source housing.

17. The method of claim 15 wherein the first concave light refractor directs light towards the proximal and distal ends of the base.

18. The method of claim 15 wherein the base comprises a plurality of light dispensing lobes positioned on the top and bottom ends of the base and wherein a second light refractor is concave and dispenses light vertically through the light dispensing lobes.

19. The rub rail of claim 15 wherein a third light refractor is concave and reflects light internally throughout the base.

20. A light refracting insert adapted to be mounted in rub rail to direct a light source, the insert comprising:
a. A first concave light refractor that forms a dual or single concave lens that directs the light source horizontally towards the proximal and distal sides of the rub rail;
b. A second concave light refractor that dispenses the light source vertically towards the top and bottom side of the rub rail; and
c. A third concave light refractor that reflects the light source internally throughout the rub rail.
